(19) United States
(12) Patent Application Publication
(10) Pub. No.: US 2020/0253378 A1
(43) Pub. Date: Aug. 13, 2020

(54) A HANGING ITEM

(71) Applicant: LEGO A/S, Billund (DK)

(72) Inventors: Rikke Høgstrup MØLGAARD, Billund (DK); Søren Hansen HINGE, Billund (DK); Søren HOLM, Billund (DK)

(21) Appl. No.: 16/639,835

(22) PCT Filed: Aug. 27, 2018
(86) PCT No.: PCT/EP2018/073001

§ 371 Date: Feb. 18, 2020

(30) Foreign Application Priority Data
Aug. 29, 2017 (DK) PA201770648

(51) Int. Cl. A47B 96/06; F16B 21/09

(52) U.S. Cl. CPC A47B 96/066; A47G 1/1686; F16B 21/09

(57) ABSTRACT

A hanging item (50) configured for hanging on a mounting surface such as a wall, the hanging item (50) comprises a substantially planar back surface (51), the back surface (51) comprises a mounting hole (1), the mounting hole (1) comprises at least one oblong rectilinear slot (14) and a first insertion hole (10), the width of the at least one oblong rectilinear slot (14) is smaller than a cross sectional size of the first insertion hole (10), wherein the mounting hole (1) comprises a second insertion hole (11), the first insertion hole (10) and second insertion hole (11) are positioned opposed each end of the at least one oblong rectilinear slot (14), the first insertion hole 10 and the second insertion hole (11) communicate with the at least one oblong rectilinear slot (14), the first and second insertion holes are adapted for entry of a protruding support member, such as a bolt, and the at least one oblong rectilinear slot (14) adapted for the protruding support member to be slide from an insertion hole along the length of the at least one oblong rectilinear slot (14) to a resting point (20) the side surface of the at least one oblong rectilinear slot, the at least one oblong rectilinear slot (14) extends horizontally when in use condition, the mounting hole (1) is adapted to allow the hanging item to be slide sideways horizontally into hanging position, where a protruding support member rests at the at least one oblong rectilinear slot (14).

The present invention relates to a hanging item configured for hanging on a mounting surface such as a wall, the hanging item comprises a substantially planar back surface, the back surface comprises a mounting hole, the mounting hole comprises at least one oblong rectilinear slot and a first insertion hole, the width of the at least one oblong rectilinear slot is smaller than a cross sectional size of the first insertion hole.

### DESCRIPTION OF RELATED ART

It is well known to have a mounting hole on the back face of a cabinet, selves or pictures to be hanged on a wall.

Prior art disclose a large variety of different shaped mounting holes, such as keyhole-shaped, L-shaped and T-shaped mounting holes. Additionally prior art disclose a large variety of more or less complex fittings for adjusting the location of an item to be hanged on a wall, e.g. metal brackets comprising several parts to be displaced relative to each other for adjusting the position of e.g. a kitchen cabinet, such that the kitchen cabinet is positioned as desired aligned adjacent another cabinet.

Most mounting holes are shaped according to a specific shaped bracket. US patent application no. 2708088 discloses a mounting bracket comprises a rigid metallic T-shaped bracket adapted to engage with a T-shaped key slot.

AT patent no. 296525 discloses T-shaped or L-shaped slots where the slots extend obliquely against each other, so that the slots together form a circular path. Hereby, a picture hanging on a wall can be adjusted and rotated to hang properly on the wall.

However, it can be difficult to mount several elements on a wall, when the elements have to be aligned both vertically and horizontally. Additionally, it can be difficult to align several elements, when mounted juxtaposed.

Therefore, it would be desirable to provide a hanging item allowing easy mounting and allowing versatility and alteration of the hanging items from one configuration to another.

### SUMMARY OF THE INVENTION

It is therefore an object of the invention to provide a hanging item allowing easy mounting and allowing a hanging element to be mounted adjacent one or more hanging elements aligned in vertical direction, horizontally direction or in both directions.

In a first aspect of the invention one or more problems of the prior art are solved by a hanging item configured for hanging on a mounting surface, the hanging item comprising a substantially planar back surface, the back surface comprising at least two mounting holes arranged at opposite ends of the hanging item, each of the mounting holes comprising
a first oblong rectilinear slot, and
a first insertion hole, where the width of the first oblong rectilinear slot is smaller than a cross sectional size of the first insertion hole,

wherein each of the mounting holes comprises a second insertion hole, wherein the first insertion hole and second insertion hole are positioned opposed each end of the first oblong rectilinear slot, wherein the first insertion hole and the second insertion hole communicate with the first oblong rectilinear slot, wherein the first and second insertion holes are configured for insertion of a protruding support member, and the first oblong rectilinear slot is configured for the protruding support member to be slid from an insertion hole along a length of the first oblong rectilinear slot to a resting point at a side surface of the first oblong rectilinear slot, the first oblong rectilinear slot extending horizontally, wherein each mounting hole is configured to allow the hanging item to be slid sideways horizontally into a hanging position, where a protruding support member rests at the first oblong rectilinear slot of each mounting hole.

Hereby is achieved that a hanging item is easy to mount, aligned both vertically and horizontally, and allowing versatility and alteration of the hanging items from one configuration to another.

Further advantageous features are provided in the dependent claims.

In an embodiment, each of the mounting holes comprises a second oblong rectilinear slot.

In an embodiment, the second oblong rectilinear slot extends perpendicularly to a longitudinal direction of the at least one oblong rectilinear slot.

In an embodiment, the second oblong rectilinear slot extends perpendicularly from the midpoint of the at least one oblong rectilinear slot, wherein the first and second oblong rectilinear slots forms a T-shape, wherein the hanging item is configured to allow the hanging item to be slid downwards vertically into a hanging position, where a protruding support member may be slid upwards to rests at a resting point at a side surface of the at least one oblong rectilinear slot.

In an embodiment, each the mounting holes comprise a third insertion hole, and the third insertion hole is positioned at the extremity of the second oblong rectilinear slot.

In an embodiment, the third insertion hole comprises a cross sectional size larger than the width of the second oblong rectilinear slot, wherein the third insertion hole is configured for insertion of a protruding support member, and the second oblong rectilinear slot is configured for the protruding support member to be slid from the third insertion hole along a length of the second oblong rectilinear slot to a resting point at the side surface of the at least one oblong rectilinear slot.

In an embodiment, the first and second insertion holes comprise a circular shape.

In an embodiment, the first and second insertion holes has as a cross sectional size of 12-20 mm.

In an embodiment, the first and second insertion holes has as a cross sectional size of 16 mm.

The cross sectional size may be a diameter.

In an embodiment, also the third insertion hole comprises a circular shape.

In an embodiment, the third insertion hole has a cross sectional size of 12-20 mm.

In an embodiment, the third insertion hole has a cross sectional size of 16 mm.

The cross sectional size may be a diameter.

In an embodiment, the distance between a center of the first insertion hole and the second insertion hole is 28-36 mm.

In an embodiment, the distance between a center of the first insertion hole and the second insertion hole is 32 mm.

In an embodiment, a distance between a centerline through the first oblong rectilinear slot and the center point of the third insertion hole is 12-20 mm.

In an embodiment, a distance between a centerline through the first oblong rectilinear slot and the center point of the third insertion hole is 16 mm.

In an embodiment, the hanging item comprises two identical shaped mounting holes, the two identical shaped mounting holes are arranged, when in use condition, horizontally in the same plane defined by the centerline of the first oblong rectilinear slot.

In a second aspect of the invention one or more of the problems of the prior art is solved by a system comprising a mounting surface having a plurality of wall mounting holes and a hanging item according to any one of the embodiments of the first aspect of the invention.

In an embodiment the system further comprises at least two protruding support members.

The protruding support members may e.g. be bolts or screw or similar fastening members known in the art. In further embodiments, the system may two or more hanging items according to any one of the embodiments of the first aspect of the invention. Preferably, the system comprise at least two protruding support members for each hanging items.

In an embodiment of the system, the plurality of wall mounting holes are preferably arranged in grid points of a two-dimensional grid in horizontal rows and vertical columns.

In an embodiment, the plurality of wall mounting holes are arranged in a pattern having a distance, Mh, between them in horizontal direction, and a distance, Mv, between them in vertical direction, whereby the mounting holes 53 the plurality of mounting holes formed in the mounting surface are arranged in a regular two-dimensional grid, having the size Mh×Mv. In an embodiment the grid size is 150 mm×150 mm.

In an embodiment, a distance between a centre of a first and a second mounting hole of a hanging item is a multiple of the distance, Mh or Mv, between two adjacent mounting holes formed in the mounting surface.

In a further aspect of the inventions one or more of the problems of the prior art is solved by that the mounting hole comprises a second insertion hole, the first insertion hole and second insertion hole are positioned opposed each end of the at least one oblong rectilinear slot, the first insertion hole and the second insertion hole communicate with the at least one oblong rectilinear slot, the first and second insertion holes are adapted for entry of a protruding support member, such as a bolt, and the at least one oblong rectilinear slot adapted for the protruding support member to be slide from an insertion hole along the length of the at least one oblong rectilinear slot to a resting point the side surface of the at least one oblong rectilinear slot, the at least one oblong rectilinear slot extends horizontally when in use condition, the mounting hole is adapted to allow the hanging item to be slide sideways horizontally into hanging position, where a protruding support member rests at the at least one oblong rectilinear slot.

Hereby is achieved that a hanging item is easy to mount, aligned both vertically and horizontally, and allowing versatility and alteration of the hanging items from one configuration to another.

Further advantageous features are provided in the dependent claims.

In an embodiment, the mounting hole comprises a second oblong rectilinear slot.

In an embodiment, the second oblong rectilinear slot extends perpendicular to the longitudinal direction of the at least one oblong rectilinear slot.

In an embodiment, the second oblong rectilinear slot extending perpendicular from the midpoint of the at least one oblong rectilinear slot, the at least two slots forms a T-shape, the hanging item, when in use condition, adapted to allow the hanging item to be slide downwards vertically into hanging position, where a protruding support member may be slide upwards to rests at the resting point at a side surface of the at least one oblong rectilinear slot.

In an embodiment, the mounting hole comprises a third insertion hole, the third insertion hole is positioned at the extremity of the second oblong rectilinear slot.

In an embodiment, the third insertion hole comprises a cross sectional size larger than the width of the second oblong rectilinear slot, the third insertion hole are adapted for entry of a protruding support member, such as a bolt, and the second oblong rectilinear slot adapted for the protruding support member to be slide from the third insertion hole along the length of the second oblong rectilinear slot to the resting point at the side surface of the at least one oblong rectilinear slot.

In an embodiment, the first second and third insertion hole comprises a circular shape having the cross sectional size of 12-20 mm, preferably 16 mm.

In an embodiment, the distance between the center of the first second insertion hole and the third insertion hole 11 is 28-36 mm, preferably 32 mm.

In an embodiment, the distance between the centerline through the at least one oblong rectilinear slot and the center point of the third insertion hole is 12-20 mm, preferably 16 mm.

In an embodiment, the hanging item comprises two identical shaped mounting holes, the two identical shaped mounting holes are arranged, when in use condition, horizontally in the same plane defined by the centerline of the at least one oblong rectilinear slot.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a three dimensional (perspective) view of a hanging item,

FIG. 2 shows a side view of a hanging item,

FIG. 3 shows an enlarged detail view of a hanging item,

FIG. 4 shows an embodiment of a mounting hole,

FIG. 5 shows a hanging item to be placed on a mounting surface, and

FIG. 6, in a sectional view, shows details of a mounting surface and a hanging item with an oblong rectilinear slot forming part of a mounting hole, and a protruding support member 54 configured for connecting the hanging item to the mounting surface.

### DETAILED DESCRIPTION OF THE EMBODIMENTS

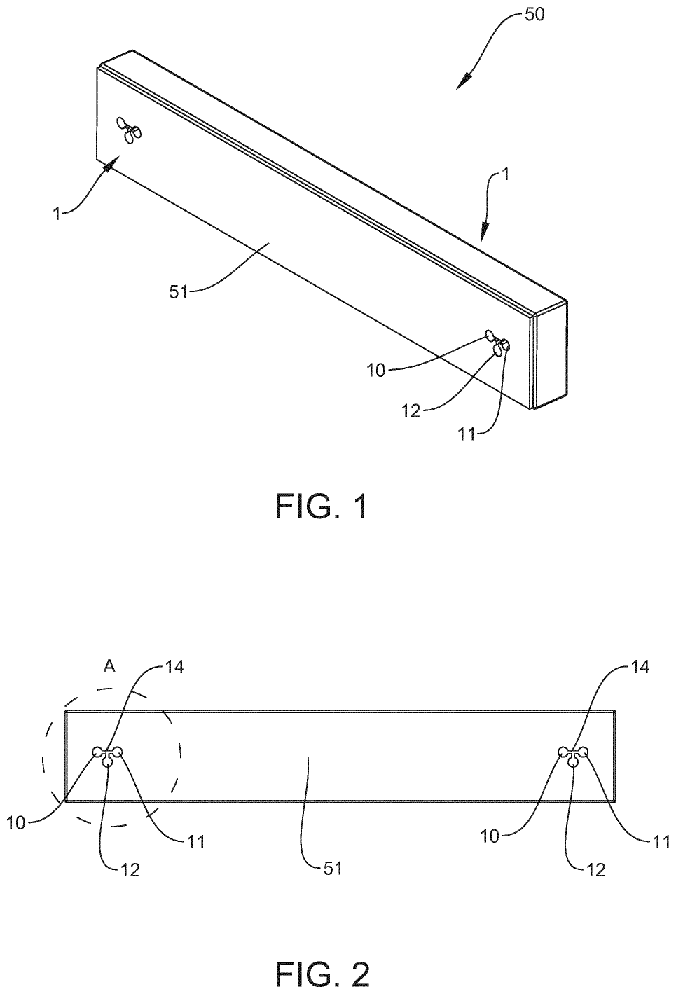

FIGS. 1-3 show different views of one embodiment of a hanging item according to the present invention.

FIG. 1 shows a three dimensional view or perspective view of a hanging item 50, such as a shelf, the hanging item 50 being configured/adapted to hang on a mounting surface 52, such as a wall.

The mounting surface 52 may be a wall, such as a wall of a building. The mounting surface 52 may alternatively be a wall element or plate structure configured to be mounted at an existing wall, or provide a cladding of a wall structure in general.

The hanging item 50 comprises a substantially planar back surface 51 adapted to be positioned juxtaposed a mounting surface 52, such as a wall.

The back surface 51 comprises two mounting holes 1. The two mounting holes 1 are arranged/positioned at opposite ends of the longitudinal hanging item 50.

FIG. 2 shows a side view of the hanging item 50.

Two mounting holes 1 are positioned on the back surface 51 of the hanging item 50. The mounting holes 1 comprise an oblong, horizontally arranged, rectilinear slot, first oblong rectilinear slot 14 and two insertion holes 10, 11, arranged at each end of the first oblong rectilinear slot 14. The hanging item 50 comprises two identical shaped mounting holes 1. The two identical shaped mounting holes 1 are arranged, when the hanging item 50 is in use condition, horizontally in the same plane defined by the centerline of the oblong first rectilinear slot 14.

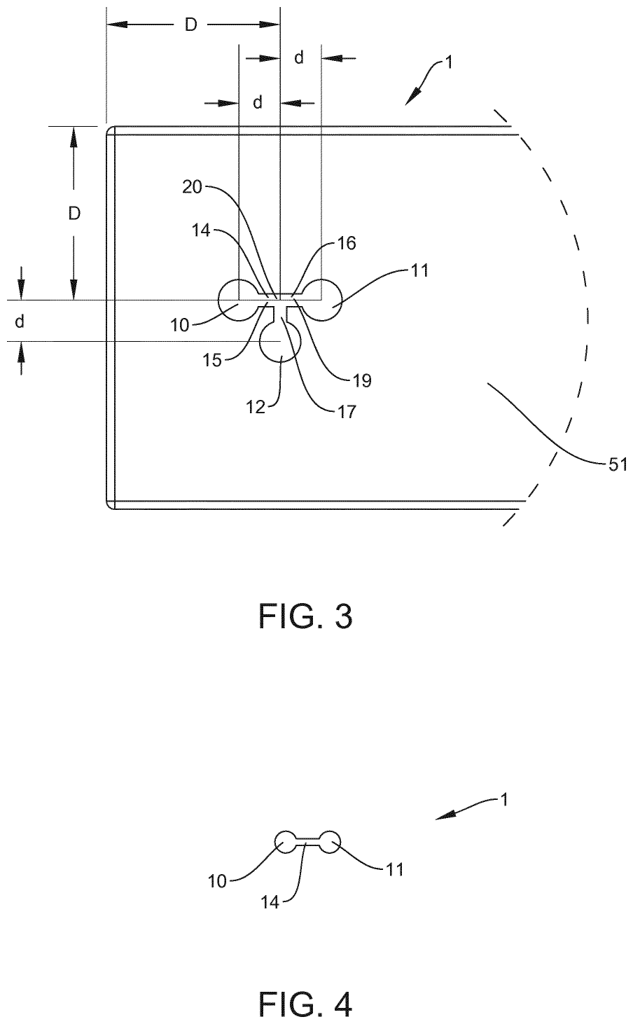

The encircled section, detail A, in FIG. 2 is shown in an enlarged view in FIG. 3.

FIG. 3 shows an enlarged view of the mounting hole 1. The mounting holes 1 comprise a first oblong rectilinear slot 14 and a second oblong rectilinear slot 17.

The first oblong rectilinear slot 14 is divided into two identical slot sections, sub sections 15, 16. The second oblong rectilinear slot 17 extends perpendicular to the longitudinal direction of the first oblong rectilinear slot 14.

The oblong rectilinear slot 14 comprises a rectilinear upper side surface 19 adapted for engaging a protruding support member 54, such as a bolt, to rest against, when the hanging item 50 is mounted on a mounting surface 52.

When in use condition, the hanging item 50 is configured to allow the hanging item 50 to be slid sideways horizontally into hanging position, where a protruding support member 54 may be slid sideways/horizontally (relative to the hanging item 50) in the first oblong rectilinear slot 14, to rest at the rectilinear upper side surface 19 of the oblong rectilinear slot 14.

The second oblong rectilinear slot 17 extends perpendicularly from a midpoint of the at least one oblong rectilinear slot 14 (first oblong rectilinear slot 14), the two slots—first oblong rectilinear slot 14 and second oblong rectilinear slot 17 forming/showing a T-shape. When in use condition, the hanging item 50 is configured/adapted to allow the hanging item 50 to be slid downwards vertically into hanging position, where a protruding support member 54 may be slid upwards (relative to the hanging item 50) in the second oblong rectilinear slot 17, to rest at the rectilinear upper side surface 19 of the oblong rectilinear slot 14.

At the midpoint 20 of the oblong rectilinear slot 14, between the first sub section 15 and the second sub section 16 of the first oblong rectilinear slot 14, a resting point 20 is marked. The resting point 20 is positioned vertically above the second oblong rectilinear slot 17.

The first and second insertion holes 10, 11 comprises a cross sectional size/dimension, which is larger than the width of the first oblong rectilinear slot 14. The first and second insertion holes 10, 11 are configured for insertion/entry of a portion, such as a head 55 of a protruding support member 54. The protruding support member may e.g. be a bolt or a screw. The first oblong rectilinear slot 14 is adapted for the protruding support member 54 to be slid from the first or the second insertion hole 10, 11 along the length of the first oblong rectilinear slot 14 to rest at a point along the side surface 19 of the oblong rectilinear slot 14, e.g. the resting point 20 at the middle thereof.

The mounting hole 1 comprises a third insertion hole 12, the third insertion hole 12 is positioned at the extremity of the second oblong rectilinear slot 17, and opposite the junction between the first and second oblong rectilinear slots 14, 17.

The third insertion hole 12 comprises a cross sectional size larger than the width of the second oblong rectilinear slot 17. The third insertion hole is adapted for insertion/entry of a portion, such as a head 55 of a protruding support member 54, such as a bolt. The second oblong rectilinear slot 17 is adapted for the protruding support member 54 to be slid from the third insertion hole 12 along the length of the second oblong rectilinear slot 17 to the resting point 20 at the side surface 19 of the oblong rectilinear slot 14.

The first, second and third insertion hole 10, 11, 12 comprises a circular shape having a cross sectional size (diameter) of 12-20 mm, preferably 16 mm.

The distance between the center of the first insertion hole 10 and the center of the second insertion hole 11 is 28-36 mm, preferably 32 mm. In FIG. 3 this is illustrated by a distance, d, from the center of each of the first and the second insertion holes 10, 11 to a midpoint 20/resting point 20 of a centerline through the at least one oblong rectilinear slot 14. Thus, the distance between the center of the first insertion hole 10 and the center of the second insertion hole 11 in general is 2×d.

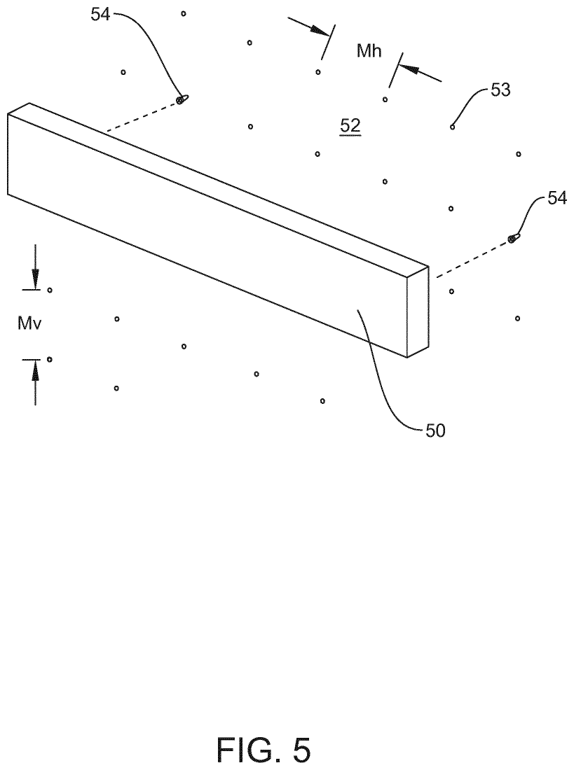

Also illustrated in FIG. 3 is that a distance, d, vertically between the centerline through the at least one oblong rectilinear slot 14 and the center point of the third insertion hole 12 is preferably the same as the above mentioned distance, i.e. 12-20 mm, preferably 16 mm. Further, in FIG. 3 it is illustrated that the midpoint 20/resting point 20 between the centers of the first and second insertion holes 10, 11 at the ends of the at least one oblong rectilinear slot 14 is located at a distance, D, from at least two edges of the hanging item 50. The distance, D, is preferably half of a distance Mh and/or My between wall mounting holes 53 with protruding support member 54, see FIG. 5 and the description thereof further below. Preferably, the distance D is 75 mm.

Generally, a hanging item 50, such as a shelf can be pushed horizontal from an insertion hole 10, 11 to the desired hanging position at the resting point 20, either from left to right or the opposite way from right to left. Hereby two shelves can be hung close together.

The vertical slot 17 allows a hanging item 50 to be mounted close above another hanging item 50, and then moved downwards into desired hanging position juxtaposed the hanging item below.

FIG. 4 illustrates another embodiment of a mounting hole 1.

The mounting hole comprises two insertion holes 10, 11 and a horizontal oblong rectilinear slot 14, that connects the two insertion holes 10,11. The first insertion hole 10 and second insertion hole 11 are positioned opposed each end of the oblong rectilinear slot 14.

The two insertion holes 10,11 comprises a shape and size adapted to allow a protruding support member, such as a bolt to enter the two insertion holes 10,11 and then passed horizontal through the horizontal oblong rectilinear slot 14.

Generally, the insertion holes 10, 11 comprises a cross sectional size larger than the width of the third horizontal oblong rectilinear slot 14.

Generally, the third insertion hole 12 comprises a cross sectional size larger than the width of the second horizontal oblong rectilinear slot 17.

FIG. 5 illustrates a mounting surface 52 comprising a plurality of wall mounting holes 53. The plurality of wall mounting holes 53 are positioned in grid points of a two-dimensional grid.

The grid points of the two-dimensional grid are positioned in horizontal rows and vertical columns; such that the wall mounting holes 53 are arranged in a regular two dimensional grid. The wall mounting holes 53 are arranged in a pattern having a distance between them in horizontal direction illustrated in the figure by Mh in FIG. 5.

In the vertical direction the mounting holes are arranged in a pattern having a distance between two mounting holes 53 in the vertical direction illustrated by My in FIG. 5.

Generally, the grid points are arranged in a regular two-dimensional grid having the size Mh×My, such as 150 mm×150 mm. The grid points are arranged in a pattern, such that the wall mounting holes 53 are aligned horizontally and vertically having a distance of 150 mm between two adjacent mounting holes 53, horizontally and vertically.

The hanging item 50 comprises two mounting holes 1 as described above, and arranged such that a distance between the resting points 20 of two mounting holes 1 corresponds to the distances between two or more wall mounting holes 53 arranged in grid points of the regular two-dimensional grid.

In an embodiment, the distance between the centre of two mounting holes 1 corresponds to one or more of the distances between two horizontally arranged wall mounting holes 53 positioned on grid point of a regular two-dimensional grid.

Thus, the distance between the centres of the two mounting holes 1 at each end of the hanging item 50 is an integer multiple of the distances between two or more wall mounting holes 53 formed in the mounting surface 52.

In FIG. 5 two protruding support members 54, such as bolts, are mounted on the mounting surface 52 at two wall mounting holes 53. The two wall mounting holes 53 are positioned in the same horizontal row.

In FIG. 5, the two protruding support members 54 are mounted at a distance of 750 mm (5×150 mm).

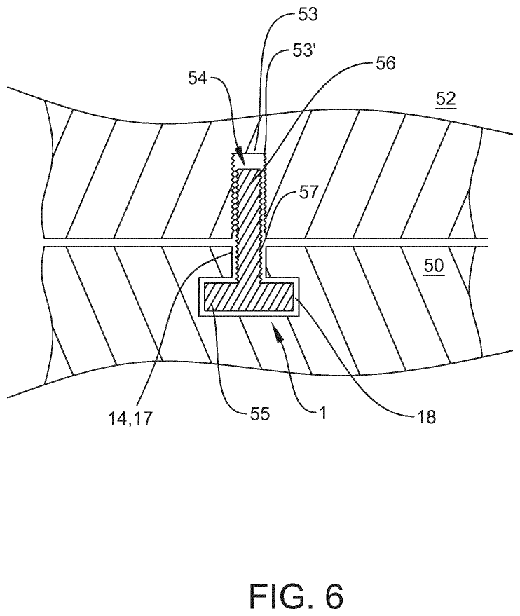

The insertion holes 10, 11, 12 are configured to receive a head 55 of a protruding support member 54. The protruding support member 54 may be a bolt or a screw or the like, and have a main body 56, which may be fully or partially provided with a threading 57, the main body being formed in extension of the head 55, see FIG. 6. The threading 57 on the main body 56 of the protruding support member 54 is configured to mate with a corresponding threading 53′ formed in the wall mounting holes 53.

The head 55 has a lager dimension than the main body 56 of the protruding support member 54. A width of the first or second oblong rectilinear slot 14, 17 is smaller than the dimensions of the head 55, but corresponds to a dimension of the main body 56 of the protruding support member 54.

Each of the first and second oblong rectilinear slot 14, 17 has a lower slot portion 18 with a larger width than the width of the first and second oblong rectilinear slot 14, 17. The width lower slot portion 18 is configured to receive the head 55 of the protruding support member 54. This is illustrated in FIG. 6.

The invention also concerns a system comprising a mounting surface 52, having a plurality of wall mounting holes 53 and a hanging item according to any one of the embodiments described above. The system may further comprise at least two the protruding support member 54 according to any one of the embodiments described above.

The mounting surface 52 of the system may be a wall, such as a wall of a building. The mounting surface 52 may alternatively be a wall element or plate structure configured to be mounted at an existing wall, or provide a cladding of a wall structure in general.

The plurality of wall mounting holes 53 of the system are preferably arranged in grid points of a two-dimensional grid. The grid points of the two-dimensional grid are positioned in horizontal rows and vertical columns; such that the wall mounting holes 53 are arranged in a regular two dimensional grid. The wall mounting holes 53 are arranged in a pattern having a distance between them in horizontal direction as illustrated by Mh in FIG. 5. In the vertical direction the mounting holes 53 are arranged in a pattern having a distance between two mounting holes 53 in the vertical direction as illustrated by My in FIG. 5.

Generally, the grid points of the mounting holes 53 of the mounting surface 52 of the system are arranged in a regular two-dimensional grid, having the size Mh×Mv, such as 150 mm×150 mm.

A hanging item 50 of the system comprises two mounting holes 1 as described above, and arranged such that a distance between the resting points 20 of two mounting holes 1 corresponds to the distances between two or more wall mounting holes 53 arranged in grid points of the regular two-dimensional grid.

In an embodiment of the system, the distance between the centre of two mounting holes 1 corresponds to one or more of the distances between two horizontally arranged wall mounting holes 53 positioned on grid point of a regular two-dimensional grid. Thus, the distance between the centres of the two mounting holes 1 at each end of the hanging item 50 is an integer multiple of the distances between two or more wall mounting holes 53 formed in the mounting surface 52.

Generally, the invention relates to a hanging item 50 configured for hanging on a mounting surface such as a wall, the hanging item 50 comprises a substantially planar back surface 51, the back surface 51 comprises a mounting hole 1, the mounting hole 1 comprises at least one oblong rectilinear slot 14 and a first insertion hole 10, the width of the at least one oblong rectilinear slot 14 is smaller than a cross sectional size of the first insertion hole 10, where the mounting hole 1 comprises a second insertion hole 11, the first insertion hole 10 and second insertion hole 11 are positioned opposed each end of the at least one oblong rectilinear slot 14, the first insertion hole 10 and the second insertion hole 11 communicate with the at least one oblong rectilinear slot 14, the first and second insertion holes are adapted for entry of a protruding support member, such as a bolt mounted in a mounting surface, and the at least one oblong rectilinear slot 14 adapted for the protruding support member to be slide from an insertion hole along the length of the at least one oblong rectilinear slot 14 to a resting point the side surface of the at least one oblong rectilinear slot, the at least one oblong rectilinear slot 14 extends horizontally when in use condition, the mounting hole 1 is adapted to allow the hanging item to be slide sideways horizontally into hanging position, such that a protruding support member rests at an upper side surface of the at least one oblong rectilinear slot 14.

1. A hanging item configured for hanging on a mounting surface, the hanging item comprising a substantially planar back surface, the back surface comprises at least a first mounting hole and a second mounting hole arranged at opposite ends of the hanging item, wherein the first mounting hole and the second mounting hole each comprises
a first oblong rectilinear slot,
a first insertion hole, the width of the first oblong rectilinear slot is smaller than a cross sectional size of the first insertion hole, and
a second insertion hole,
wherein the first insertion hole and second insertion hole are positioned opposed each end of the first oblong rectilinear slot, wherein the first insertion hole and the second insertion hole communicate with the first oblong rectilinear slot, wherein the first and second insertion holes are configured for insertion of a protruding support member, and the first oblong rectilinear slot is configured for the protruding support member to be slid from an insertion hole along a length of the first oblong rectilinear slot to a resting point at a side surface of the first oblong rectilinear slot, the first oblong rectilinear slot extending horizontally; and
wherein the first and second mounting holes are configured to allow the hanging item to be slid sideways horizontally into a hanging position, where a first protruding support member rests at the first oblong rectilinear slot of the first mounting hole, and a second protruding support member rests at the first oblong rectilinear slot of the first mounting hole.

2. A hanging item according to claim 1, wherein each of the mounting holes comprises a second oblong rectilinear slot.

3. A hanging item according to claim 2, wherein the second oblong rectilinear slot extends perpendicularly to a longitudinal direction of the at least one oblong rectilinear slot.

4. A hanging item according to claim 2, wherein the second oblong rectilinear slot extends perpendicularly from the midpoint of the at least one oblong rectilinear slot, wherein the first and second oblong rectilinear slots forms a T-shape, wherein the hanging item is configured to allow the hanging item to be slid downwards vertically into a hanging position, where a protruding support member may be slid upwards to rests at a resting point at a side surface of the at least one oblong rectilinear slot.

5. A hanging item according to claim 2, wherein each the mounting holes comprises a third insertion hole, and wherein the third insertion hole is positioned at the extremity of the second oblong rectilinear slot.

6. A hanging item according to claim 5, wherein the third insertion hole comprises a cross sectional size larger than the width of the second oblong rectilinear slot, wherein the third insertion hole is configured for insertion of a protruding support member, such as a bolt, and the second oblong rectilinear slot is configured for the protruding support member to be slid from the third insertion hole along a length of the second oblong rectilinear slot to a resting point at the side surface of the at least one oblong rectilinear slot.

7. A hanging item according to claim 5, wherein the first, second and third insertion hole each comprises a circular shape having a cross sectional size of 12-20 mm, preferably 16 mm.

8. A hanging item according to claim 1, wherein a distance between a center of the first insertion hole and the second insertion hole is 28-36 mm, preferably 32 mm.

9. A hanging item according to claim 5, wherein a distance between a centerline through the first oblong rectilinear slot and the center point of the third insertion hole is 12-20 mm, preferably 16 mm.

10. A hanging item according to claim 1, further comprising two identical shaped mounting holes, the two identical shaped mounting holes are arranged, when in use condition, horizontally in the same plane defined by the centerline of the first oblong rectilinear slot.

11. A system comprising a mounting surface having a plurality of wall mounting holes and a hanging item according to claim 1.

12. A system according to claim 11 further comprising at least two protruding support members.

13. A system according to claim 11, wherein the plurality of wall mounting holes are preferably arranged in grid points of a two-dimensional grid in horizontal rows and vertical columns.

14. A system according to claim 13, wherein a distance between a centre of a first and a second mounting hole of a hanging item is a multiple of a distance between two adjacent mounting holes formed in the mounting surface.
